(19) United States
(12) Patent Application Publication
(10) Pub. No.: US 2007/0266120 A1
(43) Pub. Date: Nov. 15, 2007

(54) System and method for handling instructions in a pre-boot execution environment

(75) Inventors: Joseph Tallieu, Austin, TX (US); Vijay Narayana Reddy Halaharvi, Austin, TX (US); Gong Jer Yeh, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/431,229

(22) Filed: May 10, 2006

(51) Int. Cl. G06F 15/177

(52) U.S. Cl. 709/220; 709/222

(57) ABSTRACT

Systems and methods for handling instructions in a pre-boot execution environment are disclosed. A controlling server may connect to a pre-boot control (PBC) proxy server via a network and transmit over the network from the controlling server to the PBC proxy server instructions for a pre-boot task to be completed by a network bootstrap program (NBP) on a client system connected to the PBC proxy server. The NBP may poll the PBC proxy server to determine if any instructions for a pre-boot task to be completed are available. If instructions are available, the instructions may be transmitted from the PBC proxy server to the NBP, and the pre-boot task executed by the NBP on the client system. If instructions are not available, the NBP may sleep for a specified interval of time and repoll the PBC proxy server after the specified interval.

### TECHNICAL FIELD

The present disclosure relates generally to computer systems and information handling systems, and, more specifically, to a system and method for handing pre-boot instructions from a controlling server.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

When a user attempts to boot a computer system in an information handling system that includes only one computer system, the information handling system will typically respond to the boot command by retrieving certain files from the computer system's local, non-volatile memory that provide operating instructions for the computer system. These files, commonly referred to as an “operating system,” or “OS,” prepare the computer for normal operation. The computer system may also retrieve other files needed to operate other hardware components in the information handling system, such as printers or external memory devices. When a user attempts to boot a computer system in an information handling system that includes multiple computer systems, however, the information handling system may need to respond differently. For example, an information handling system might include a server that is connected to several client computer systems via a centralized network. The client computer systems might not include a copy of an operating system stored in local, non-volatile memory. When the user attempts to boot one of the client computer systems, that client computer system will issue a request for a copy of operating system files, and any other files necessary for operation of connected peripherals, to the server via the centralized network. The server will act as a boot server and provide the requested information. This process of remote booting allows the client computers to, for example, reserve memory space for other files.

The Preboot Execution Environment (PXE), detailed in Version 2.1 of the Preboot Execution Environment Specification, provides a uniform and consistent pre-boot environment within a booting client computer system. PXE allows an information handling system to bootstrap client computers using a network interface card regardless of the availability of local storage devices, the manufacturer of the hardware, and other system-specific characteristics. When a user starts up a client computing system that does not have a native OS, PXE firmware will allow the client computing system to locate and identify a desired Network Bootstrap Program (NBP) on a remote server using the Dynamic Host Configuration Protocol (DHCP) and its extensions. The client computer can then download and execute an image of desired NBP.

Many current PXEs, however, provide only limited facilities for handing pre-boot instructions on demand from remote controlling systems, such as servers. In some situations, pre-boot instructions must be preconfigured in the NBP on the server before the NBP can be deployed on client computer systems. If a user wishes to change the pre-boot instructions, the user must rebuild or reconfigure the NBP on the PXE server and have it redeployed to the client. This reconfiguration and redeployment will require a reboot of the client computer system. Moreover, any pre-boot instructions bound to a specific client computer system will require the server to have prior knowledge of any such client in order for the server to deploy an NBP specific to the client computer system. These added steps carry significant administration overhead in managing NBPs and client computer systems. Certain other pre-boot solutions deploy interactive NBPs that can handle instructions that are input into the client computer system. The user will then act as the controlling body in the booting process. This solution requires less server administration, but it does not permit remote-control of a client computer system.

### SUMMARY

In accordance with the present disclosure, systems and methods for handling instructions in a pre-boot execution environment are disclosed. In one method, a controlling server may connect to a pre-boot control (PBC) proxy server via a network and transmit over the network from the controlling server to the PBC proxy server instructions for a pre-boot task to be completed by a network bootstrap program on a client system connected to the PBC proxy server. The client system may connect to the PBC proxy server via the network and download the NBP onto the client system. The NBP may poll the PBC proxy server to determine if any instructions for a pre-boot task to be completed are available. If instructions are available, the instructions may be transmitted over the network from the PBC proxy server to the NBP on the client system, and the task executed with the NBP on the client system. If instructions are not available, the NBP may sleep for a specified interval of time and repoll the PBC proxy server after the specified interval.

The systems and methods described herein are technically advantageous because they permit the controlling server to provide instructions for pre-boot tasks to the NBP on the client system via the PBC proxy system even if the client system and controlling server are never connected to the PBC proxy system at the same time. The controlling server may therefore “remotely” control one or more client systems without having to be directly connected to the client system. NBPs on client systems can be configured before the client systems are booted. Furthermore, the NBPs on the client systems can be controlled while the client systems are operating without requiring a reboot.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is block diagram of an example information handling system;

FIG. 2 is a block diagram of a portion of an example information handling system including a client system, a pre-boot control (PBC) proxy server;

FIG. 3 is a block diagram of a portion of an example information handling system indicating information flow from a controlling server to a PBC proxy server;

FIG. 4 is a block diagram of a portion of an example information handling system indicating information flow from a client system to a PBC proxy server;

FIG. 5 is a block diagram of a portion of an example information handling system indicating information flow from a PBC proxy server to a client system;

FIG. 6 is a block diagram of a portion of an example information handling system indicating information flow from a client system to a PBC proxy server;

FIG. 7 is a block diagram of a portion of an example information handling system indicating information flow from a PBC proxy server to a controlling server; and

FIG. 8 is a flowchart indicating a method for handling instructions in a pre-boot execution environment.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

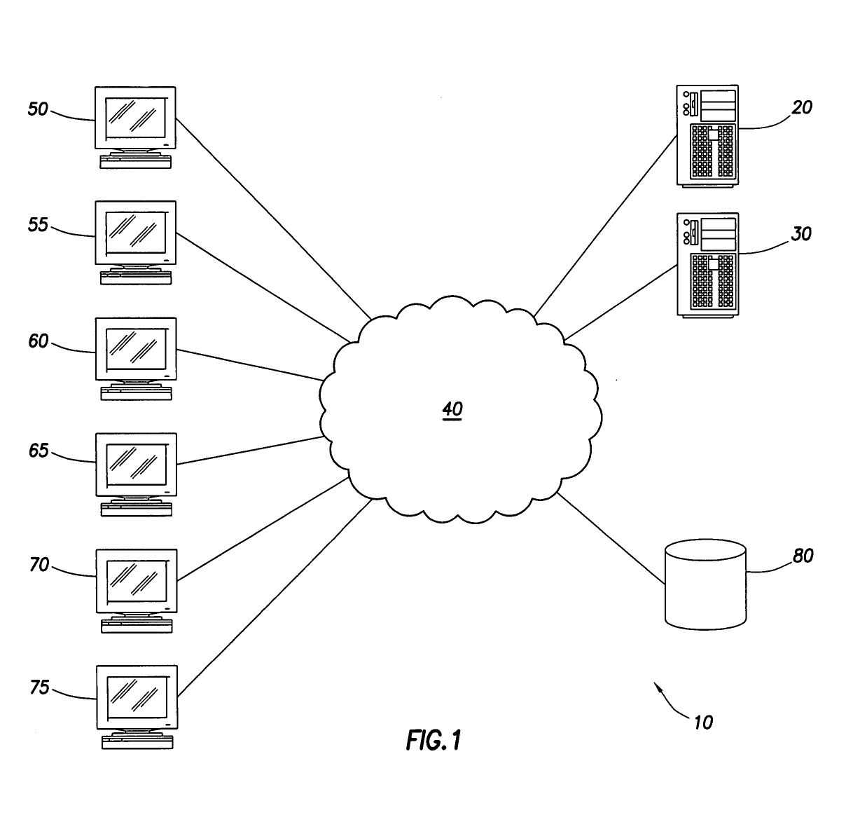

FIG. 1 illustrates an example information handling system 10. Information handling system 10 includes a controlling server 20, as well as an additional server 30, known as the pre-boot control (PBC) proxy server. Controlling server 20 and PBC proxy server 30 electronically connected via a network 40. Network 40 provides communication links between various devices and computers, such as controlling server 20 and PBC proxy server 30. Network 40 may include connections such as wires, wireless communications links, fiber optic cables, switches, and other connections. Network 40 may also include components joined via the Internet, an intranet, a local-area network, or a wide-area network. In FIG. 1, six client systems, numbered 50, 55, 60, 65, 70, and 75, respectively, connect to network 40. The client systems may be, for example, personal computers, terminals, or network computers. Information handling system 10 may include additional or fewer client systems, as desired. Further, information handling system may include additional components such as storage unit 80 or other devices that are not shown in FIG. 1.

In the example information handling system 10 shown in FIG. 1, client systems 50, 55, 60, 65, 70 and 75 require deployment of an NBP upon startup in order to function properly. Client systems 50, 55, 60, 65, 70, and 75 will therefore include pre-boot extensions to download NBP. When a user starts up one of the client systems, such as client system 50, firmware on that client system will perform a DHCP broadcast to discover PBC proxy server 30 in a manner known to those of ordinary skill in the art. PBC proxy server 30 will then send a DHCP offer to client system 50 containing the address of a Boot Image Negotiation Layer (BINL) server, which then directs client system 50 to a Trivial File Transfer Protocol (TFTP) server with a suitable NBP. For the example system in FIG. 1, the BINL server and TFTP server are collocated on PBC proxy server 30; in other information handling systems, the BINL server, TFTP server, and PBC proxy servers may be located on different server hardware. Once this step is complete, client system 50 can download and execute the necessary NBP.

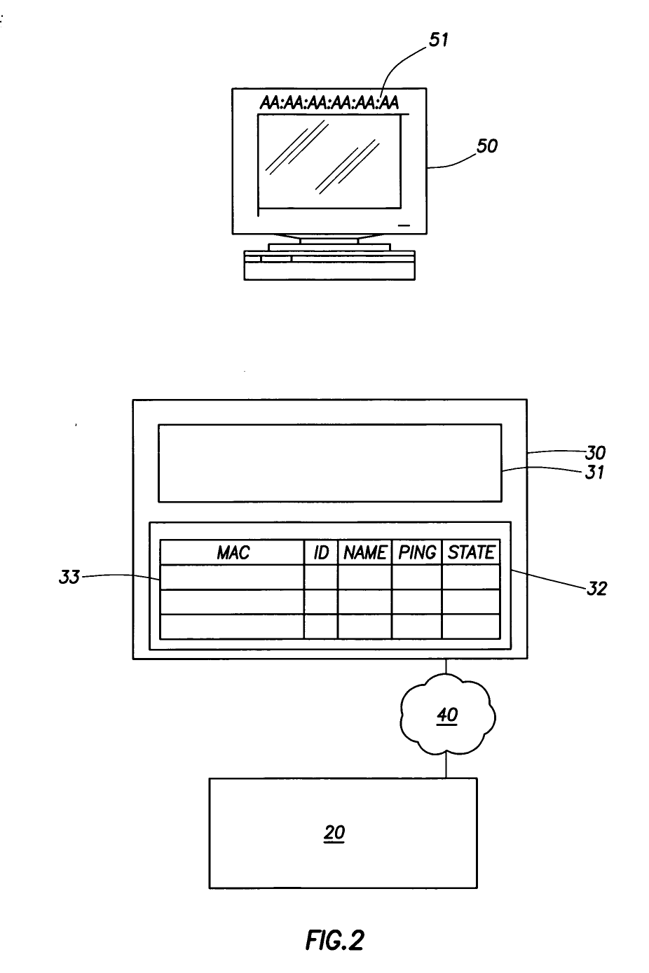

Information handling system 10 permits controlling server 20 to provide pre-boot instructions to client systems 50, 55, 60, 65, 70, or 75, regardless of whether client system 50 is connected to PBC proxy server 30. FIGS. 2 through 7 illustrate the flow of information during this control process in greater detail. FIG. 2 illustrates a portion of information handling system 10, with certain components of information handling system 10 omitted for simplicity. FIG. 2 first illustrates one of the client systems in information handling system 10, client system 50. As shown in FIG. 2, client system 50 includes a unique identifier 51, such as a Media Access Control (MAC) address or service tag. FIG. 2 also illustrates that PBC proxy server 30 includes a client monitor 31. Client monitor 31 is a network plug-in that monitors for incoming communications from client systems such as client system 50. PBC proxy server 30 also includes a PBC agent 32, a task execution plug-in. Client monitor 31 has a plug-in manager interface that communicates with PBC agent 32. PBC agent 32 includes a table 33 that serves as a cache for tasks, as we will explain in greater detail later in this disclosure. Finally, PBC proxy server 30 is connected to controlling server 20 via network 40. At this stage in the process, client system 50 need not be connected to PBC proxy server 30 or controlling server 20.

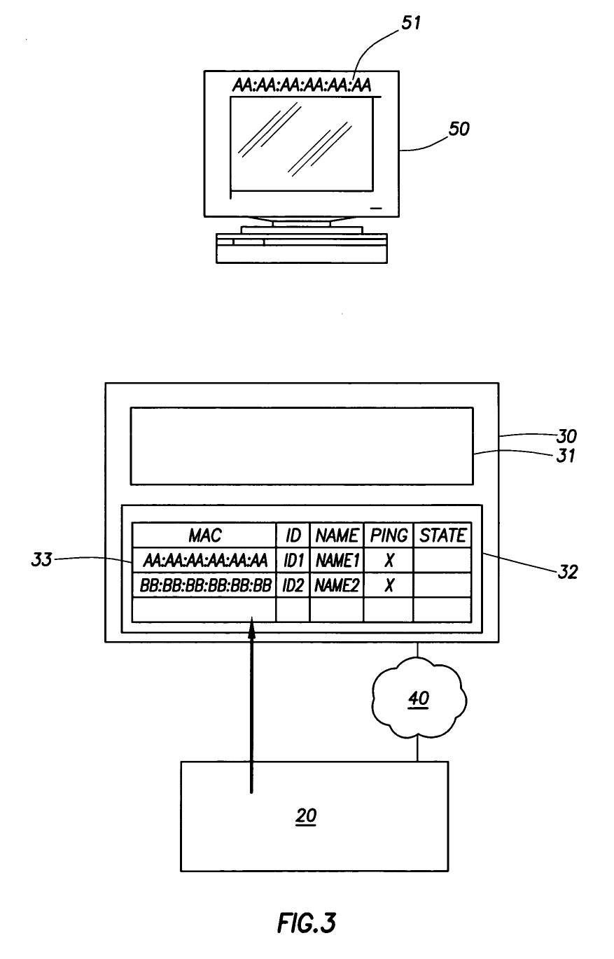

FIG. 3 includes the same portion of information handling system 10 as FIG. 2. As indicated by the arrow in FIG. 3, however, controlling server 20 sends to PBC proxy server 30 information relating to one or more pre-boot tasks for a NBP to execute on one or more client systems. Example tasks include booting or installing an operating system, displaying a boot menu, or querying for system inventory. For each pre-boot task, the information may be in the form of a “RunTask” instruction coupled with a unique identifier for the client system(s) on which controlling server 20 wants the NBP to complete the task. The RunTask instruction may be sent without a unique identifier for a particular client system; the pre-boot task would then be executed by the NBP on every client system that connected to PBC proxy server 30. The instructions may also include a task ID, ping instructions, the task instructions, and any other information necessary to complete the task. PBC agent 32 will populate table 33 with the information from PBC proxy server 30. For example, controlling server 20 has sent information to PBC proxy server 30 for two pre-boot tasks. The first task includes MAC address 51 and is therefore destined for client system 50. The second task includes a MAC address for another client system not illustrated in FIG. 3. This second task is not intended for client system 50. Alternatively, however, the tasks may be sent without unique identifiers for particular client systems.

In FIG. 3, PBC agent 32 has populated table 33 with the two instructions. Once PBC agent 32 has received all of the currently-available task information from controlling server 20, controlling server 20 is free to disconnect from PBC proxy server 30. This permits controlling server 20 to remotely control client system 50, as client system 50 need only connect to PBC proxy server 30 to receive an NBP that will execute the desired task instructions, as described below. However, controlling server 20 may remain connected to PBC proxy server if controlling server 20 will send tasks to PBC proxy server 30 on a rolling basis. That is, if controlling server 20 anticipates sending future task instructions during the operation of client system 50, controlling server 20 could remain connected to PBC proxy server 30. Alternatively, controlling server 20 could disconnect and reconnect to PBC proxy server 30 as necessary.

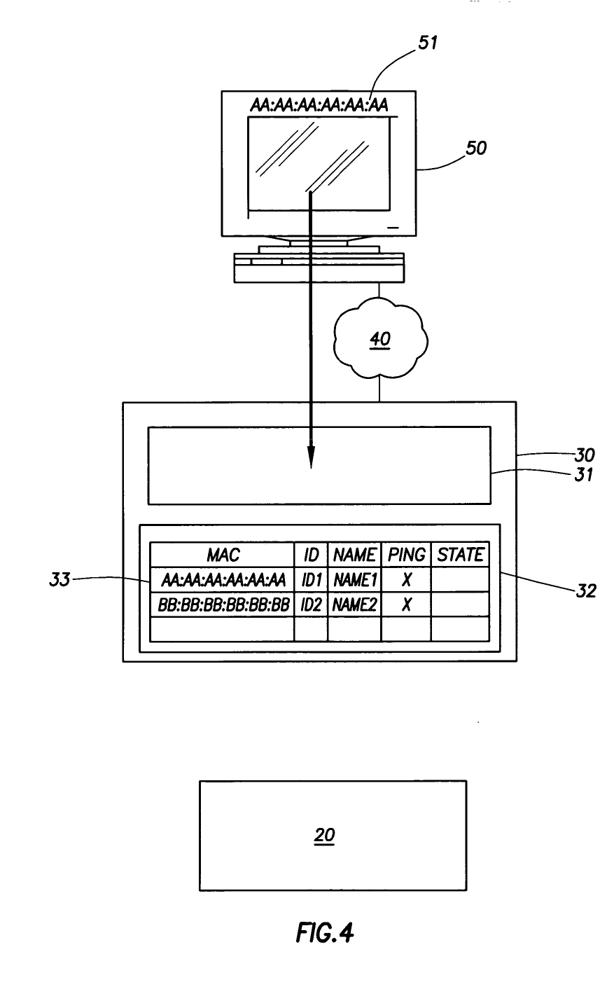

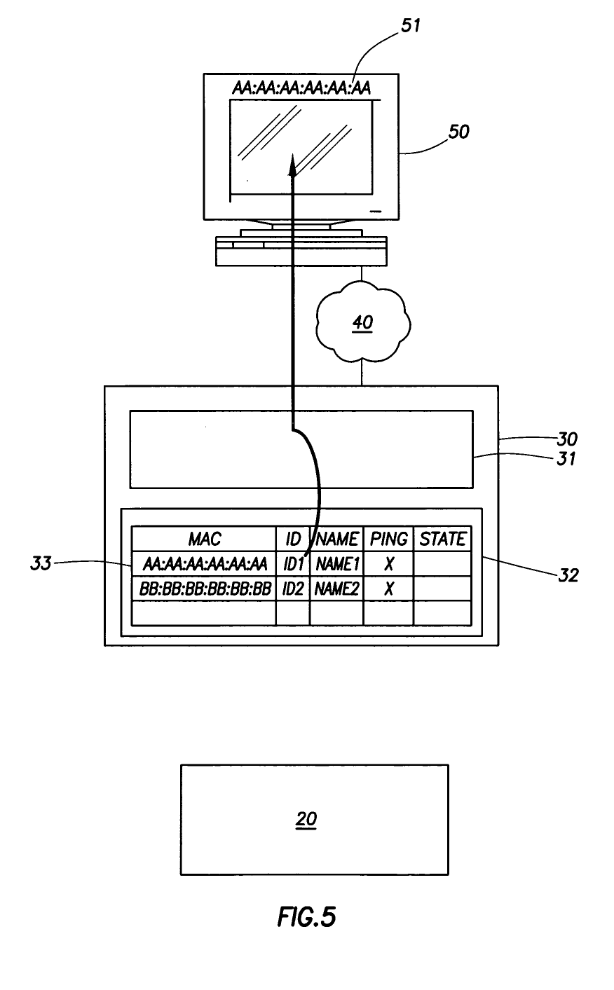

As described previously in this disclosure, upon startup, firmware on client system 50 will lead client system 50 to discover PBC proxy server 30, connect to PBC proxy server 30, and load and execute or boot the appropriate NBP. The client typically must be PXE booted in an ordinary manner either by physically powering the system or by remotely powering the system using remote wake-up technology known to those of ordinary skill in the art. In FIG. 4, the user has instructed the NBP on client system 50 to boot to the OS on the local hard drive. The NBP on client system 50 will poll PBC proxy server 30 to determine whether it needs to perform a pre-boot task by sending a “GetTask” request coupled with the unique identifier associated with client system 50, such as its MAC address, to client monitor 31. Client monitor 31 will examine table 33 in PBC agent 32 and retrieve any tasks that are in table 33 that are designated as tasks for client system 50. For the system shown in FIG. 4, client monitor will retrieve the first task for client system 50, namely the instruction to boot to the local OS on the client hard drive, because only the first task lists MAC address 51. As shown in FIG. 5, client monitor 31 will then send the information needed to complete the task, such as the task instructions, via network 40 to client system 50. Client system 50 will execute the task. If, however, table 33 does not include any tasks designated for client system 50, client system 50 will sleep for a specified interval. At the end of the interval, client system 50 will poll client monitor 31 to see if a task for client system 50 has been entered into table 33. If not, client system 50 will sleep for the specified interval again and then poll again.

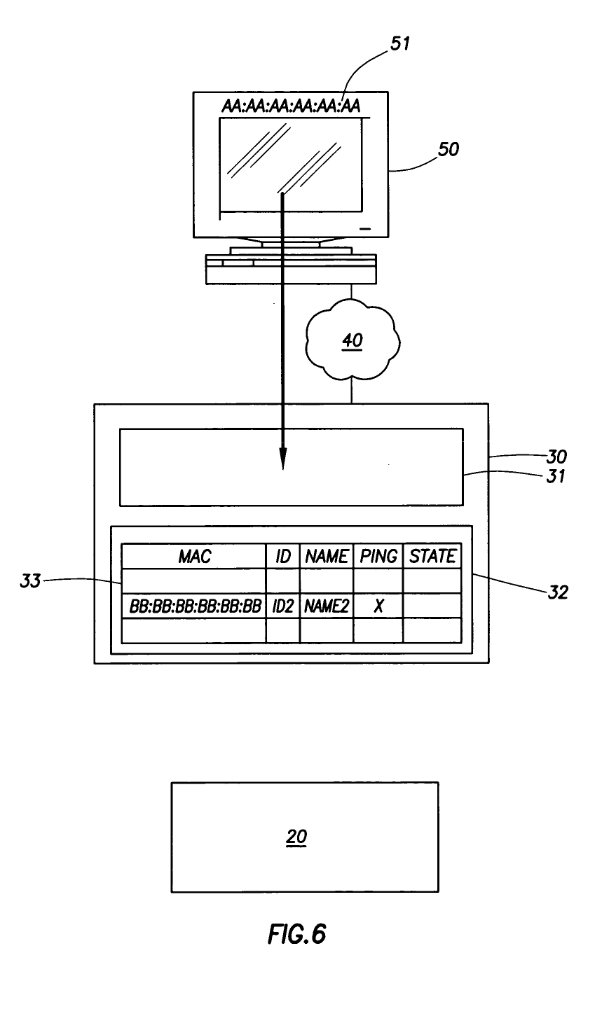

As shown in FIG. 6, when client 50 is handling the task instructions, the NBP on client system 50 will send a “Running” message to client monitor 31, coupled with the unique identifier for client system 50, to update table 33 (e.g., an “UpdateState” message). Client monitor 31 will then send a “KeepAlive” message to PBC proxy agent 32, update the ping time associated with the task in table 33, and check to see if the PBC Proxy agent 32 has issued an abort flag to abort the tasks. If no abort flags have been issued, the NBP on client system 50 will complete the task and send a “Done” message coupled with the unique identifier for client system 50 to client monitor 31. Client monitor 31 will then instruct PBC agent 32 to purge the entry for the completed task from table 33 (by sending, e.g., another “Update State” message).

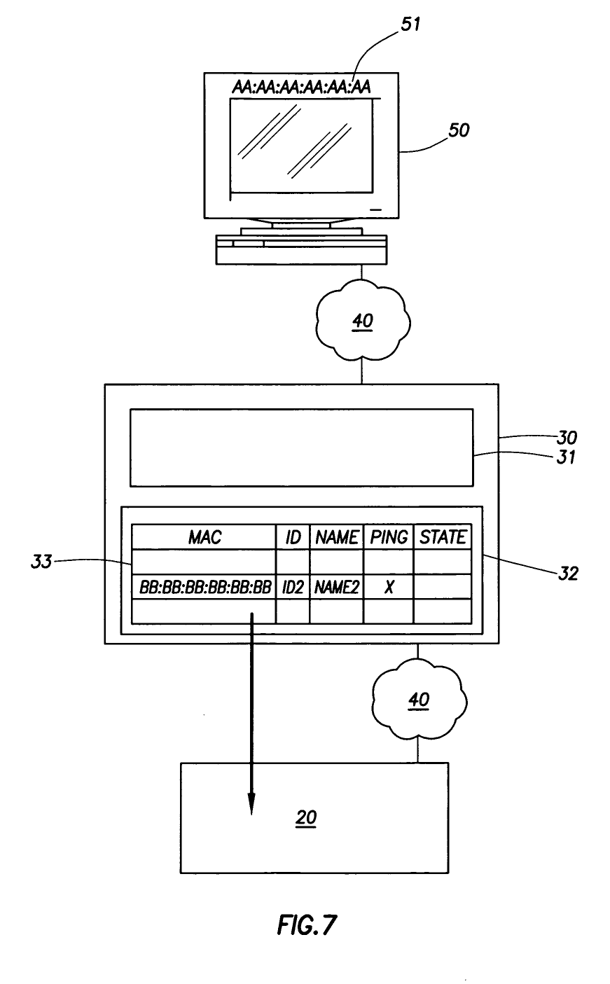

As shown in FIG. 7, if controlling server 20 is still connected to PBC proxy server 30, PBC proxy server 30 may then send a message to controlling server 20 indicating that the task complete, along with the unique identifier for the client system that completed the task. If controlling server 20 has disconnected from PBC proxy server 30, PBC proxy server can store the message and delay sending it until it reconnects to controlling server 20.

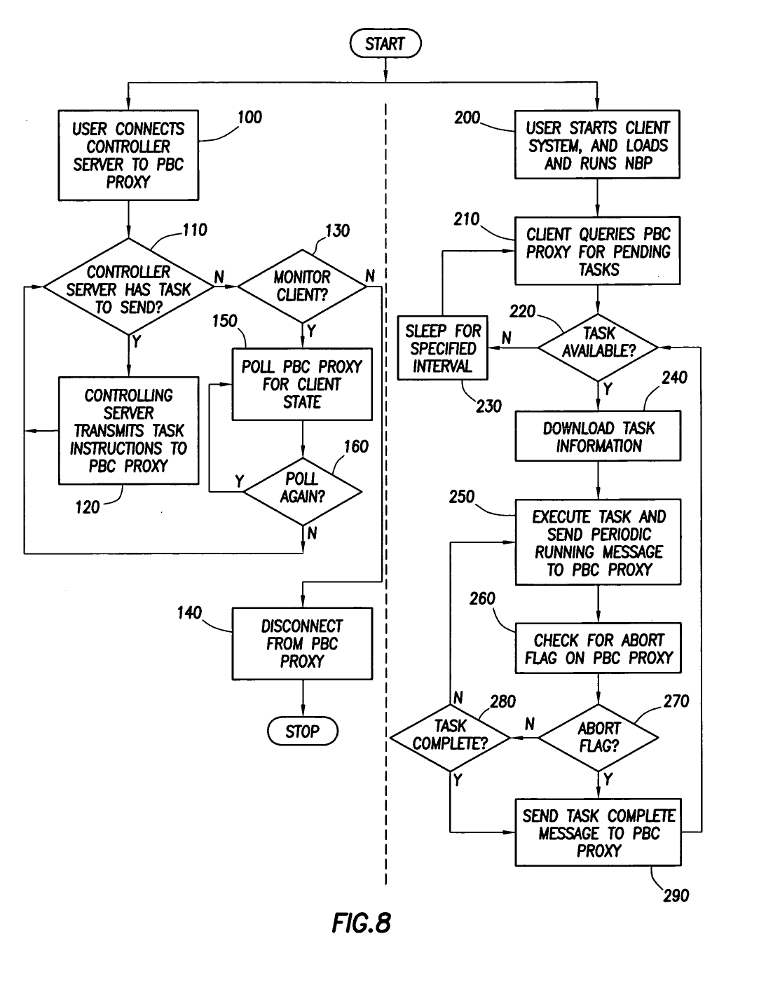

FIG. 8 includes a flow diagram that illustrates the processes described in FIGS. 2 through 7 in two separate paths divided by a dashed line that are to be executed in parallel. Steps to the left of the dashed line are to be completed on controlling server 20 and PBC proxy server 30; steps to the right of the dashed line are to be completed on one or more client systems in parallel with the steps occurring on controlling server 20 and PBC proxy server 30. As shown in box 100, the user first establishes a connection between controlling server 20 and PBC proxy server 30. As shown in box 110, controlling server 20 may or may not have a task available for execution on one or more client systems. If controlling server 20 has a task to send one or more client systems, controlling server 20 will then transmit information relating to that task to PBC proxy server 30, as shown in box 120. PBC proxy agent 32 will populate table 33 with the information relating to the task(s). If no task is available, the next inquiry will be whether to monitor any client systems, as indicated in box 130. If monitoring the client is unnecessary, controlling server 20 will disconnect from PBC proxy, as shown in box 140. If monitoring is required, controlling server 20 will poll PBC proxy server 30 to determine the state of one or more client machines. Generally, controlling server 20 will periodically repoll PBC proxy server 30 in a loop, such as the one formed by boxes 150 and 160 in FIG. 8, for either a set time interval or a set number of polls. After that time period has elapsed, or after controlling server 20 has repolled PBC proxy server for the set number of times, controlling server 20 will return to the step shown in box 110, either restarting the task transmittal and execution process or the client monitoring process.

While controlling server 20 and PBC proxy server 30 are performing the steps in the first path as described above, one or more client systems and the PBC proxy server 30 will perform the steps in the second path, shown on the right side of the dashed line in FIG. 8. A user will start a client system, as shown in box 200. The client system will load and boot or execute the appropriate NBP. The NBP on the client system will poll PBC proxy server 30, with a “GetTask” message and unique client identifier to client monitor 31 sent via network 40, as shown in box 210, to determine whether table 33 lists any tasks for that particular client system, as shown in box 220. If no task for that client system is listed, the NBP on the client system will sleep for a specified interval and then poll PBC proxy server 30 again for a task, as shown by the loop of boxes 230, 210, and 220. If a task for that client system is listed, the NBP on the client system will download the task instructions and related information from PBC proxy server 30, as shown in box 240. The NBP on the client system will begin handling task and periodically send a “Running” message with a unique client identifier to client monitor 31 in PBC proxy server 30. For example, the NBP may send an “Update State” message instructing the client monitor in PBC proxy server 30 to update table 33. Client monitor 31 will send a “KeepAlive” message to PBC agent 32, update the ping time, and search for abort flags, a shown in box 260. If no abort flag has issued, the next inquiry is whether the client system has finished executing the assigned task, as shown in block 280. If not, the client system continues executing the task, and the NBP will continue to send periodic Running messages, as shown in box 250. If an abort flag has issued, or if no abort flag has issued but the client system has executed the task, the client system will notify client monitor 31, which will then instruct PBC agent 32 to purge the task from table 33, as shown in box 290. If controlling server 20 is still connected to PBC proxy server 30, PBC proxy server 30 will notify controlling server 20 that the client system has completed the task. Although this step is not depicted in FIG. 8, if controlling server 20 has disconnected from PBC proxy server 30, PBC proxy server 30 may store a message regarding the completed status of the task until controlling server reconnects to PBC proxy 30. After reconnection, PBC proxy server 30 will then notify controlling server 20 that the task is complete.

Instead of purging entries in table 33 immediately upon task completion, table 33 could alternatively provide space for an entry describing the status of each task. For example, table 33 could include a “State” column that accepts four entries: Not yet started, Pending, Aborted, and Completed. Each time controlling server 20 connected to PBC proxy server 30, it could inquire as to the status of entries in table 33. Once the status inquiry is complete, PBC agent 32 could then purge entries for all aborted and completed tasks. Although the present disclosure has been described in detail, it should be understood that various changes, substitutions, and alterations can be made hereto without departing from the spirit and the scope of the invention as defined by the appended claims.

What is claimed is:

1. A method for handling instructions in a pre-boot execution environment, comprising the steps of:
connecting a controlling server to a pre-boot control proxy server (PBC proxy server) via a network;
transmitting over the network from the controlling server to the PBC proxy server instructions for a pre-boot task to be completed by a network bootstrap program (NBP) on a client system connected to the PBC proxy server via the network;
connecting the client system to the PBC proxy server via the network;
downloading the NBP onto the client system;
polling the PBC proxy server with the NBP to determine if any instructions for a pre-boot task to be completed by the NBP on the client system are available;
transmitting over the network from the PBC proxy server to the NBP on the client system the instructions for the pre-boot task to be completed by the NBP, if the instructions are available;
executing the pre-boot task with the NBP on the client system, if the instructions are available; and
sleeping the NBP for a specified interval of time and repolling the PBC proxy server with the NBP after the specified interval, if no instructions for a pre-boot task to be completed by the NBP are available.

2. The method for handling instructions in a pre-boot execution environment of claim 1, further comprising the steps of:
repolling the PBC proxy server with the NBP to determine if any instructions for a second pre-boot task to be completed by the NBP are available;
retransmitting over the network from the PBC proxy server to the NBP on the client system the instructions for the second pre-boot task to be completed by the NBP, if the instructions are available;
executing the second pre-boot task with the NBP on the client system, if the instructions are available; and
sleeping the NBP for a specified interval of time and repolling the PBC proxy server with the NBP after the specified interval, if no instructions for a second pre-boot task to be completed by the NBP are available.

3. The method for handling instructions in a pre-boot execution environment of claim 1, further comprising the step of transmitting from the controlling server to the PBC proxy server while a client system is running additional instructions for a pre-boot task to be completed by an NBP on that client system.

4. The method for handling instructions in a pre-boot execution environment of claim 1, wherein the step of connecting the controlling server to the PBC proxy server via the network is completed before the step of connecting the client system to the PBC proxy server via the network.

5. The method for handling instructions in a pre-boot execution environment of claim 1, further comprising the step of disconnecting the controlling server from the PBC proxy server.

6. The method for handling instructions in a pre-boot execution environment of claim 5, wherein the step of disconnecting the controlling server from the PBC proxy server is completed before the step of connecting the client system to the PBC proxy server via the network.

7. The method for handling instructions in a pre-boot execution environment of claim 1, further comprising the step of populating a table stored on the PBC proxy server with entries related to instructions for a pre-boot task to be completed by an NBP.

8. The method for handling instructions in a pre-boot execution environment of claim 7, further comprising the step of purging entries from the table that are related to instructions for pre-boot tasks completed by the NBP.

9. The method for handling instructions in a pre-boot execution environment of claim 7, further comprising the steps of:
indicating in the table the status of a pre-boot task to be completed by an NBP; and
polling the controlling server for the status of the pre-boot task to be completed by the NBP.

10. The method for handling instructions in a pre-boot execution environment of claim 1, wherein the step of transmitting over the network from the controlling server to the PBC proxy server instructions for a pre-boot task to be completed by an NBP on a client system connected to the PBC proxy server via the network comprises transmitting over the network from the controlling server to the PBC proxy server instructions for a pre-boot task to be completed by an NBP on a client system connected to the PBC proxy server via the network with a unique identifier for the client system.

11. The method for handling instructions in a pre-boot execution environment of claim 1, further comprising the step of notifying the PBC proxy server when the NBP is executing instructions for a pre-boot task.

12. The method for handling instructions in a pre-boot execution environment of claim 1, further comprising the step of notifying the controlling server when the NBP has executed a pre-boot task.

13. The method for handling instructions in a pre-boot execution environment of claim 12, further comprising the step of storing a notification message regarding the status of a pre-boot task on the PBC proxy server.

14. A method for handling instructions in a pre-boot execution environment, comprising the steps of:
connecting a controlling server to a pre-boot control proxy server (PBC proxy server) via a network;
transmitting over the network from the controlling server to the PBC proxy server instructions for a pre-boot task to be completed by a network bootstrap program (NBP) on a client system connected to the PBC proxy server via the network;
populating a table on the PBC proxy server with entries relating to the instructions for a pre-boot task to completed by the NBP, wherein the entries comprise the instructions for the pre-boot task and a unique identifier for the client system;
connecting the client system to the PBC proxy server via the network;
downloading the NBP onto the client system;
polling the PBC proxy server with the NBP to determine if any instructions for a pre-boot task to be completed by the NBP are available, wherein polling comprises sending a request for a task from the NBP to the PBC proxy server with a unique identifier for the client system;
transmitting over the network from the PBC proxy server to the NBP on the client system the instructions for the pre-boot task to be completed by the NBP, if the instructions are available;
executing the pre-boot task with the NBP on the client system, if the instructions are available; and
sleeping the NBP for a specified interval of time and repolling the PBC proxy server with the NBP after the specified interval, if no instructions for a pre-boot task to be completed by the NBP are available.

15. The method for handling instructions in a pre-boot execution environment of claim 14, further comprising the step of notifying the PBC proxy server when the NBP is executing instructions for a pre-boot task.

16. The method for handling instructions in a pre-boot execution environment of claim 15, further comprising the step of checking for an abort flag on the PBC proxy server relating to the execution of instructions for the pre-boot task.

17. The method for handling instructions in a pre-boot execution environment of claim 14, further comprising the step of notifying the PBC proxy server when the NBP has executed instructions for a pre-boot task.

18. The method for handling instructions in a pre-boot execution environment of claim 14, further comprising the step of polling the PBC proxy server to determine the state of the client system.

19. A system for handling instructions in a pre-boot execution environment, comprising:
at least one client system;
a network bootstrap program (NBP) on the at least one client system;
a pre-boot control (PBC) proxy server coupled to the at least one client system via a network;
a controlling server coupled to the PBC proxy server via the network at least at some point in time before the client system is coupled to the PBC proxy server, wherein the controlling server includes instructions for at least one pre-boot task to be executed by the NBP on the at least one client system and wherein the controlling server can transmit the instructions for the at least one pre-boot task to the PBC proxy server, which then can transmit the instructions for the at least one pre-boot task to the NBP.

20. The system for handling instructions in a pre-boot execution environment of claim 19, further comprising:
a client monitor plug-in on the PBC proxy server, wherein the client monitor plug-in can communicate with the NBP on the at least one client system via the network;
a PBC agent plug-in on the PBC proxy server; and
a table on the PBC proxy server, wherein the PBC agent can populate the table with entries relating to the instructions for the at least one pre-boot task to be completed by the NBP on the at least one client system.
